(19) United States
(12) Patent Application Publication
(10) Pub. No.: US 2026/0061464 A1
(43) Pub. Date: Mar. 5, 2026

(54) Electrostatic Field Dust Removal Device

(71) Applicant: Suzhou University of Science and Technology, Suzhou (CN)

(72) Inventor: Xing ZHANG, Suzhou (CN)

(73) Assignee: Suzhou University of Science and Technology, Suzhou (CN)

(21) Appl. No.: 19/377,608

(22) Filed: Nov. 3, 2025

Related U.S. Application Data
(63) Continuation of application No. PCT/CN2024/141148, filed on Dec. 20, 2024.

(30) Foreign Application Priority Data
Sep. 4, 2024 (CN) 202411233106.6

(51) Int. Cl. B08B 6/00

(52) U.S. Cl. CPC B08B 6/00

(57) ABSTRACT

An electrostatic field dust removal device, which relates to a technical field of electrostatic precipitation, includes: at least one negative electrode plate for releasing negative charges; and at least one positive electrode plate, which is alternately arranged in parallel with the at least one negative electrode plate, for receiving the negative charges released by the at least one negative electrode plate; wherein an electrostatic dust removal region and a glow plasma region are formed between each negative electrode plate of the at least one negative electrode plate and each positive electrode plate of the at least one positive electrode plate; and waste gas flows between each negative electrode plate and each positive electrode plate and is alternately purified, wherein it is purified by corona in the electrostatic dust removal region and ionized in the glow plasma region.

### CROSS-REFERENCE TO RELATED APPLICATIONS

This application is a continuation of International Patent Application No. PCT/CN2024/141148 filed on Dec. 20, 2024, which claims priority to Chinese Patent Application No. 202411233106.6 filed on Sep. 4, 2024. The disclosures of the above-referenced applications are hereby incorporated by reference in their entirety.

### BACKGROUND

In industrial production processes, such as in power plants, chemical plants, metallurgy and mining operations, fuel combustion or chemical reactions often occur concomitantly. As a result, large quantities of smoke and dust are generated during these industrial production processes. These smoke and dust contain a large number of components that are harmful to the environment. For example, industrial setting machines generally used in the printing and dyeing industry emit waste gas, and the main components of the waste gas include large quantities of smoke, dust, and lint, mixed with a large amount of oil mist, polyphenyl organic compounds, and dyeing and printing auxiliaries and the like. If the waste gas emitted is not purified and treated, their long-term accumulation inside the pipelines would further cause physical and chemical changes, which results in the generation of foul odors to pollute the environment, even cause spontaneous combustion, trigger fires, and bring about serious safety risks.

With regards to common dust removal methods, in addition to the use of various types of filter screen devices for physical isolation, the electrostatic precipitation technology is also widely applied nowadays, such as a tubular electrostatic precipitator, a plate electrode type electrostatic precipitator, an annular electric field dust removal. However, the above electrostatic precipitation devices often suffer from the component compositions of the waste gas, a specific resistance, flow parameters, etc., which results in low dust removal efficiency, failing to meet purification standards, while electric power consumption and equipment costs are generally higher.

In view of the fact that the existing electrostatic precipitation devices need to be optimized in the dust removal effect, power consumption, and safety and others, it is desired that a new type of electrostatic field dust removal device can be provided to solve the above issues in whole or in part.

### SUMMARY

In order to solve at least one aspect of the above issues and defects existing in some implementations, embodiments of this disclosure provide an electrostatic field dust removal device, which can simultaneously achieve both corona dust removal purification and plasma ionization for sterilization and odor removal of the waste gas through two ways of negative charge release.

The disclosure of the present application relates to a technical field of electrostatic precipitation, and specifically relates to an electrostatic field dust removal device.

The described technical solutions are as follows:

According to an aspect of this disclosure, an electrostatic field dust removal device is provided, wherein the electrostatic field dust removal device includes:

at least one negative electrode plate for releasing negative charges; and
at least one positive electrode plate, which is alternately arranged in parallel with the at least one negative electrode plate, for receiving the negative charges released by the at least one negative electrode plate;
wherein an electrostatic dust removal region and a glow plasma region are formed between each negative electrode plate of the at least one negative electrode plate and each positive electrode plate of the at least one positive electrode plate, and
wherein waste gas flows between each negative electrode plate and each positive electrode plate and is alternately purified, wherein it is purified by corona in the electrostatic dust removal region and ionized in the glow plasma region.

In some embodiments, at least two first spike structures are arranged on each negative electrode plate, and each negative electrode plate releases the negative charges through tips of the at least two first spike structures; and the at least two first spike structures are alternatively arranged on plate surfaces on both sides of each negative electrode plate, respectively.

Further, each positive electrode plate is correspondingly arranged with at least two second spike structures according to an arrangement of the at least two first spike structures on each negative electrode plate.

In some embodiments, the electrostatic dust removal region is formed in such a way that the tips of the at least two first spike structures on each negative electrode plate release the negative charges towards a plate surface of the positive electrode plate directly opposite thereto.

Further, the glow plasma region is formed in such a way that a flat surface of an opposite side plate surface of the plate surface where the at least two first spike structures on each negative electrode plate are located releases the negative charges towards the tips of the at least two second spike structures on the positive electrode plate directly opposite thereto.

In some embodiments, both each first spike structure of the at least two first spike structures and each second spike structure of the at least two second spike structures include at least two discharge tips, wherein the at least two discharge tips include four discharge tips which are centrally symmetrically arranged, or three discharge tips which are arranged in a triangular shape.

In some embodiments, each first spike structure is formed through following ways: by stamping each negative electrode plate, or by processing individually each first spike structure and then welding each first spike structure on each negative electrode plate; and each second spike structure is formed through following ways: by stamping each positive electrode plate, or by processing individually each second spike structure and then welding each second spike structure on each positive electrode plate.

In some embodiments, when each first spike structure on each negative electrode plate and each second spike structure on each positive electrode plate are stamped, one first spike structure and one second spike structure are formed by stamping on either of the plate surfaces, or two first spike structures and two second spike structures stacked together are formed by stamping simultaneously in the same direction on both of the plate surfaces.

In some embodiments, the plate surfaces of each negative electrode plate and each positive electrode plate are arranged as wavelike plate surfaces; and each first spike structure and each second spike structure are arranged at a center of a convex position or at a center of a concave position of the wavelike plate surfaces.

In some embodiments, at least one liquid flow guidance channel is individually provided on the plate surfaces of each negative electrode plate and each positive electrode plate.

In some embodiments, the electrostatic dust removal device further includes at least one set of spray nozzles for cleaning insulators, which are arranged on a wall of a housing close to the insulators of the electrostatic dust removal device.

In some embodiments, the electrostatic field dust removal device further includes at least one housing, wherein a set of negative electrode plates and positive electrode plates are integrally installed in each housing of the at least one housing, in order to form an electrostatic field dust removal unit; and the electrostatic field dust removal unit is integrated by connecting and fixing each housing adjacent to each other.

This disclosure further provides multiple embodiments according to the following aspects, and the contents are as follows specifically:

Aspect 1: A manufacturing method for an electrostatic field dust removal device, the manufacturing method including:
manufacturing at least one negative electrode plate for releasing negative charges; and
manufacturing at least one positive electrode plate, which is alternately arranged in parallel with the at least one negative electrode plate, for receiving the negative charges released by the at least one negative electrode plate;
wherein an electrostatic dust removal region and a glow plasma region are formed between each negative electrode plate of the at least one negative electrode plate and each positive electrode plate of the at least one positive electrode plate, and waste gas flows between each negative electrode plate and each positive electrode plate and is alternately purified, wherein it is purified by corona in the electrostatic dust removal region and ionized in the glow plasma region.

Aspect 2: The manufacturing method according to aspect 1, wherein at least two first spike structures are mounted on each negative electrode plate, and each negative electrode plate releases negative charges through tips of the at least two first spike structures; and the at least two first spike structures are alternatively mounted on plate surfaces on both sides of each negative electrode plate, respectively.

Aspect 3: The manufacturing method according to aspect 2, wherein each positive electrode plate is correspondingly mounted with at least two second spike structures according to an arrangement of the at least two first spike structures on each negative electrode plate.

Aspect 4: The manufacturing method according to aspect 3, wherein both each first spike structure of the at least two first spike structures and each second spike structure of the at least two second spike structures include at least two discharge tips, wherein the at least two discharge tips include four discharge tips which are centrally symmetrically arranged, or three discharge tips which are arranged in a triangular shape.

Aspect 5: The manufacturing method according to aspect 4, wherein each first spike structure is formed through following ways: by stamping each negative electrode plate, or by processing individually each first spike structure and then welding each first spike structure on each negative electrode plate; and each second spike structure is formed through following ways: by stamping each positive electrode plate, or by processing individually each second spike structure and then welding each second spike structure on each positive electrode plate.

Aspect 6: The manufacturing method according to aspect 5, wherein when each first spike structure on each negative electrode plate and each second spike structure on each positive electrode plate are stamped, one first spike structure and one second spike structure are formed by stamping on either of the plate surfaces, or two first spike structures and two second spike structures stacked together are formed by stamping simultaneously in the same direction on both of the plate surfaces.

Aspect 7: The manufacturing method according to any one of aspects 1-6, wherein the plate surfaces of each negative electrode plate and each positive electrode plate are arranged as wavelike plate surfaces; and each first spike structure and each second spike structure are arranged at a center of a convex position or at a center of a concave position of the wavelike plate surfaces.

Aspect 8: The manufacturing method according to aspect 7, wherein at least one liquid flow guidance channel is individually provided on the plate surfaces of each negative electrode plate and each positive electrode plate.

Aspect 9: The manufacturing method according to aspect 8, wherein the electrostatic dust removal device further includes at least one set of spray nozzles for cleaning insulators, which are arranged on a wall of a housing close to the insulators of the electrostatic dust removal device.

Aspect 10: The manufacturing method according to aspect 9, wherein the electrostatic field dust removal device further includes at least one housing, wherein a set of negative electrode plates and positive electrode plates are integrally installed in each housing of the at least one housing, in order to form an electrostatic field dust removal unit; and the electrostatic field dust removal unit is integrated by connecting and fixing each housing adjacent to each other.

Aspect 11: A purification method of using an electrostatic field dust removal device manufactured by the manufacturing method according to any one of aspects 1-10, the purification method including:
directing the waste gas to be purified to pass through the electrostatic dust removal region, and to be purified by corona in the electrostatic dust removal region, wherein the electrostatic dust removal region is formed in such a way that the tips of at least two first spike structures on each negative electrode plate release negative charges towards the plate surface of the positive electrode plate directly opposite thereto;
introducing the waste gas to be purified to the glow plasma region after passing through the electrostatic dust removal region, wherein the glow plasma region is formed in such a way that a flat surface of the opposite side plate surface of the plate surface where the at least two first spike structures on each negative electrode plate are located releases negative charges towards the tips of the at least two second spike structures on the positive electrode plate directly opposite thereto, and the waste gas is ionized in the glow plasma region to achieve odor removal and sterilization; and
directing the waste gas to be purified to alternately pass through the electrostatic dust removal region and the glow plasma region arranged in sequence.

In some embodiments, at least two first spike structures are arranged on each negative electrode plate, and each negative electrode plate releases the negative charge through tips of the at least two first spike structures; and the at least two first spike structures are alternatively arranged on plate surfaces on both sides of each negative electrode plate, respectively.

Further, each positive electrode plate is correspondingly arranged with at least two second spike structures according to an arrangement of the at least two first spike structures on each negative electrode plate.

In some embodiments, the electrostatic dust removal region is formed in such a way that the tips of at least two first spike structures on each negative electrode plate release the negative charge towards the plate surface of the positive electrode plate directly opposite thereto.

Further, the glow plasma region is formed in such a way that a flat surface of the opposite side plate surface of the plate surface where the at least two first spike structures on each negative electrode plate are located releases the negative charge towards the tips of the at least two second spike structures on the positive electrode plate directly opposite thereto.

In some embodiments, both each first spike structure of the at least two first spike structures and each second spike structure of the at least two second spike structures include at least two discharge tips, wherein the at least two discharge tips include four discharge tips which are centrally symmetrically arranged, or three discharge tips which are arranged in a triangular shape.

In some embodiments, each first spike structure is formed through following ways: by stamping each negative electrode plate, or by processing individually each first spike structure and then welding each first spike structure on each negative electrode plate; and each second spike structure is formed through following ways: by stamping each positive electrode plate, or by processing individually each second spike structure and then welding each second spike structure on each positive electrode plate.

In some embodiments, when each first spike structure on each negative electrode plate and each second spike structure on each positive electrode plate are stamped, one first spike structure and one second spike structure are formed by stamping on either of the plate surfaces, or two first spike structures and two second spike structures stacked together are formed by stamping simultaneously in the same direction on both of the plate surfaces.

In some embodiments, the plate surfaces of each negative electrode plate and each positive electrode plate are arranged as wavelike plate surfaces; and each first spike structure and each second spike structure are arranged at a center of a convex position or at a center of a concave position of the wavelike plate surfaces.

In some embodiments, at least one liquid flow guidance channel is individually provided on the plate surfaces of each negative electrode plate and each positive electrode plate.

In some embodiments, the electrostatic dust removal device further includes at least one set of spray nozzles for cleaning insulators, which are arranged on a wall of a housing close to the insulators of the electrostatic dust removal device.

In some embodiments, the electrostatic field dust removal device further includes at least one housing, wherein a set of negative electrode plates and positive electrode plates are integrally installed in each housing of the at least one housing, in order to form an electrostatic field dust removal unit; and the electrostatic field dust removal unit is integrated by connecting and fixing each housing adjacent to each other.

The electrostatic field dust removal device, as well as the manufacturing method thereof and the purification method thereof provided according to the embodiments of this disclosure have at least one or a part of at least one of the advantages as follows:
(1) by arranging correspondingly a spike structure at different positions on the positive and negative electrode plates, the electrostatic dust removal device provided by the embodiment of this disclosure realizes two negative charge release ways, forming an electrostatic dust removal region and a glow plasma region, and meanwhile purifying and ionizing the waste gas, so as to enhance the effect of the dust removal, as well as achieve odor removal and sterilization;
(2) the electrostatic dust removal device provided by the embodiment of this disclosure can substantially reduce the working current and lower the consumption of electric energy by means of the staggered arrangement of the positive and negative electrode plates and the tip discharge of the spike structure;
(3) by arranging multiple discharge tips on the spike structure, the electrostatic dust removal device provided by the embodiment of this disclosure effectively prevents the discharge tip from being passivated during repeat use, and extends the service life of the spike structure;
(4) by stamping on the positive and negative electrode plates to form the spike structure, the electrostatic dust removal device provided by the embodiment of this disclosure is simple to process, reduces the manufacturing cost, and also ensures that the structural stress is uniform;
(5) by arranging the positive and negative electrode plates as wavelike plates, the electrostatic dust removal device provided by the embodiment of this disclosure bends the waste gas flow channel appropriately, and guides the waste gas flow, in order to improve the efficiency of dust removal and purification of the waste gas;
(6) by arranging liquid flow guidance channels in the positive and negative electrode plates, the electrostatic dust removal device provided by the embodiment of this disclosure helps the water vapor in the dust removal process to avoid the discharge tip, and avoids the accumulation of water vapor from causing a discharge sparking that can result in a short circuit of the device, ensuring safe operation;
(7) the electrostatic dust removal device provided by the embodiment of this disclosure realizes cleaning and maintenance of the positive and negative electrode plates by arranging a spraying structure in the liquid flow guidance channel.

It should be understood that the above general description and the detailed descriptions below are exemplary and explanatory only, and do not limit the present application.

### BRIEF DESCRIPTION OF THE DRAWINGS

These and/or other aspects and advantages of this disclosure will become apparent and readily understood from the following description of preferred embodiments in conjunction with the accompanying drawings, wherein:

FIG. 1 is a schematic structural view of an electrostatic dust removal device according to an embodiment of this disclosure;

FIG. 2 is a schematic structural view of an integrated electrostatic dust removal device according to another embodiment of this disclosure;

FIG. 3 is a schematic structural view of a negative electrode plate of the electrostatic dust removal device shown in FIG. 1;

FIG. 4 is a schematic structural view of a positive electrode plate of the electrostatic dust removal device shown in FIG. 1;

FIG. 5 is a schematic view of a negative charge release state of the electrostatic dust removal device shown in FIG. 1 during discharge;

FIG. 6 is a schematic partially enlarged view of FIG. 5;

FIG. 7 is a top view of a first spike structure on the negative electrode plate shown in FIG. 3;

FIG. 8 is a schematic three-dimensional structural view of the first spike structure shown in FIG. 7;

FIGS. 9A and 9B are schematic views of two layout modes of the first spike structure on the negative electrode plate shown in FIG. 3; and

FIG. 10 is a schematic view of an insulator on a housing of the electrostatic dust removal device shown in FIG. 1.

### DETAILED DESCRIPTION

Hereinafter, the technical solutions of this disclosure are further specifically illustrated by way of embodiments and in conjunction with the accompanying drawings. In the description, the same or similar reference numerals indicate the same or similar parts. The following description of the embodiments of this disclosure with reference to the accompanying drawings is intended to explain the general inventive concept of this disclosure, and should not be construed as a limitation of this disclosure.

An electrostatic dust removal is one of the gas dust removal methods. In a strong electric field, dusty gas molecules are ionized into positive ions and electrons, in which the electrons encounter dust particles during they move toward the positive side, causing the dust particles to become negatively charged and adsorbed and deposited on the positive side to be collected. It is commonly used for the collection and purification of waste gas in factories like coal-fueled factories and in industrial production processes such as power stations, metallurgy, printing and dyeing, and chemical industries.

The electrostatic dust removal equipment has many advantages such as high purification efficiency, small resistance loss, high temperature resistance, and large treatment capacity. However, on the one hand, the existing electrostatic dust removal equipment has a complex structure, which requires high standards for equipment transportation, installation, and maintenance. On the other hand, the dust removal process of the existing electrostatic dust removal equipment has certain selectivity to the composition of the waste gas such as the type of dust and its corresponding resistance value, and the state of the waste gas such as the temperature and humidity of the waste gas, and there are obvious differences in dust removal effects under different conditions.

Considering the issues existing in the electrostatic dust removal equipment described above, an embodiment of this disclosure provides a novel electrostatic field dust removal device 100, to optimize the design of the discharge way of the electrostatic field, and to simultaneously realize both the corona dust removal purification and the plasma ionization for sterilization and odor removal of the waste gas.

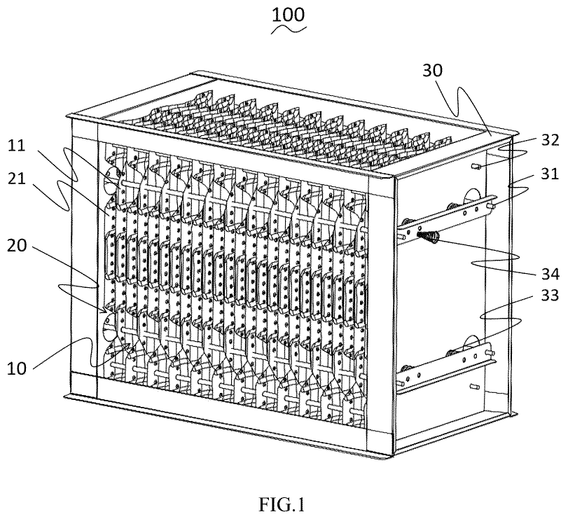

Referring to FIG. 1, an overall structure of the electrostatic field dust removal device 100 is shown. Specifically, at least one negative electrode plate 10 and at least one positive electrode plate 20 are fixedly mounted inside a housing 30. The at least one negative electrode plate 10 and the at least one positive electrode plate 20 are alternately arranged in parallel with each other, the at least one negative electrode plate 10 is used for releasing negative charges, and the at least one positive electrode plate 20 is used for receiving the negative charge released by the at least one negative electrode plate 10. An electrostatic dust removal region and a glow plasma region are formed between each negative electrode plate 11 of the at least one negative electrode plate 10 and each positive electrode plate 21 of the at least one positive electrode plate 20. The waste gas flows between each negative electrode plate 11 and each positive electrode plate 21 and is alternately purified, wherein it is purified by corona in the electrostatic dust removal region and ionized in the glow plasma region.

In one example, as shown in FIG. 1, the electrostatic field dust removal device 100 is further provided with a positioning tube 31 for the negative electrode plate for fixing the at least one negative electrode plate 10, and the positioning tube 31 for the negative electrode plate penetrates through the housing 30 through the positioning holes correspondingly provided on each negative electrode plate 11 and end surfaces of the housing 30, and fixes the at least one negative electrode plate 10. Similarly, a positioning tube 32 for the positive electrode plate is arranged to fix the at least one positive electrode plate 20.

In one example, an insulator 33 and a high-voltage connector 34 are also arranged on the outside of the housing 30 of the electrostatic field dust removal device 100. Since the negative electrode plate 11 and the positive electrode plate 21, which are in charge of discharging electricity to form an electrostatic field, are both arranged inside the housing 30, and each has a plate-like structure, the insulator 33 of the housing 30 can be uniformly arranged on the outside of the housing 30, which can be isolated from the electric field and the waste gas and enable being hidden through the housing 30, improving an operational stability of the electrostatic field dust removal device 100.

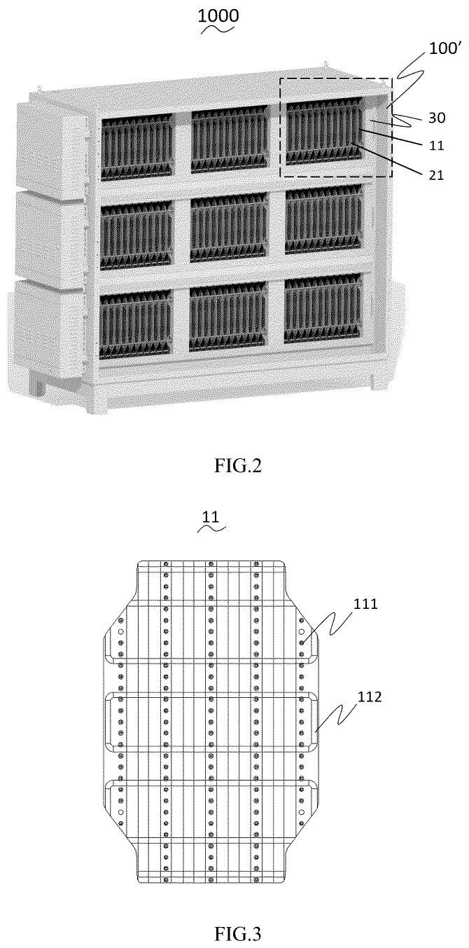

In one example, referring to FIG. 2, an integrated electrostatic field dust removal device 1000 is shown which is formed by a combination of stacked electrostatic field dust removal devices 100 as shown in FIG. 1. Alternatively, the integrated electrostatic field dust removal device 1000 includes at least one housing, wherein a set of negative electrode plates including at least one negative electrode plate 10 and positive electrode plates including at least one positive electrode plate 20 are integrally installed in each housing 30 of the at least one housing, in order to form an electrostatic field dust removal unit 100′, and the integrated electrostatic field dust removal device 1000 is formed by the electrostatic field dust removal units 100′ which are integrated by connecting and fixing each housing 30 adjacent to each other. As shown in FIG. 2, an integrated electrostatic field dust removal device 1000 is presented, which includes a set of electrostatic field dust removal units 100′ in a 3×3 array, with the electrode plate installation way of each electrostatic field dust removal unit 100′ being the same. Regarding design details and solutions of the integrated electrostatic field dust removal device 1000, such as how many electrostatic field dust removal units 100′ need to be integrated or how several electrostatic field dust removal units 100′ are arranged, etc., those skilled in the art can arrange and combine them according to the situations of the actual use scenario, such as waste gas emission volume, power consumption, site layout. This example is only an illustrative one, and those skilled in the art should not construe it as a limitation on this disclosure.

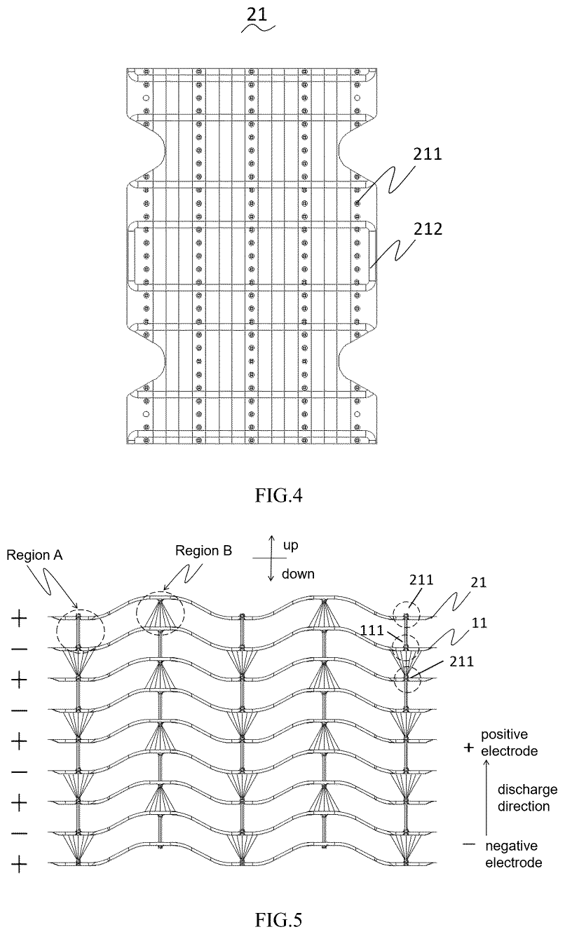

In one example, the at least one negative plate 10 and the at least one positive plate 20 need a matching design, to ensure their discharge paths and to form a uniform and stable electrostatic field within the housing 30 of an electrostatic field dust removal device 100. As shown, FIG. 3 illustrates a structure of a negative plate 11, and correspondingly, FIG. 4 illustrates a structure of a positive plate 21. Based on the structures of the positive and negative electrode plates illustrated in FIGS. 3 and 4, as shown, FIG. 5 illustrates the discharge paths of several positive and negative electrode plates disposed inside the housing 30 in an alternating and parallel manner.

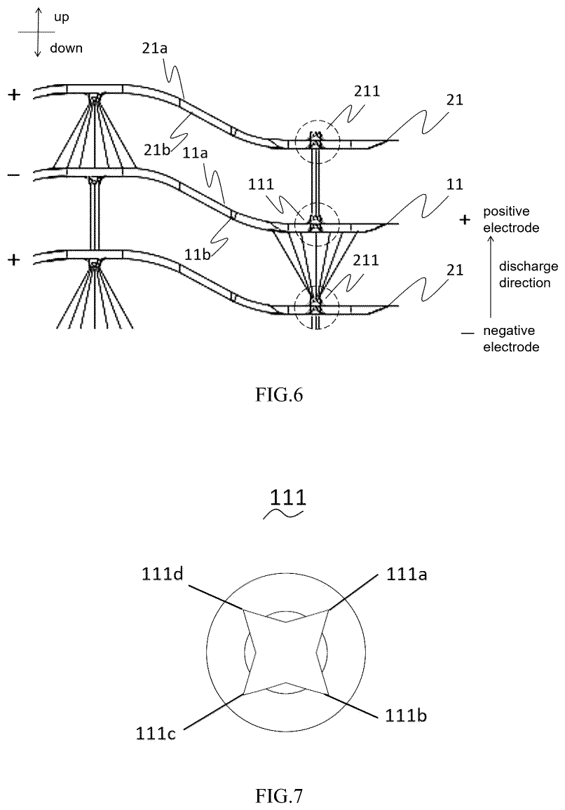

Specifically, in one example, as shown in FIGS. 3 and 5, at least two first spike structures 111 are provided on each negative electrode plate 11, and each negative electrode plate 11 releases negative charges through tips of the at least two first spike structures 111. Further, as shown in FIG. 5, the at least two first spike structures 111 are alternatively arranged on plate surfaces on both sides of each negative electrode plate 11, respectively. Correspondingly, as shown in FIGS. 4 and 5, each positive electrode plate 21 is correspondingly disposed with at least two second spike structures 211 according to an arrangement of the at least two first spike structures 111 on each negative electrode plate 11. Furthermore, referring to FIG. 5 in conjunction with the partially enlarged view as shown in FIG. 6, for example, if a first spike structure 111 with an upward tip is arranged at the right-most end of an upper layer plate surface of the first negative electrode plate 11 at the upper parts of the views, then the two adjacent positive electrode plates 21 above and below it are each arranged correspondingly with a second spike structure 211 in exactly the same position and direction, and so on, the other first spike structures 111 and the other second spike structures 211 are each arranged in the same manner.

Specifically, in one example, as shown in FIGS. 3 and 4, multiple rows and multiple columns of the first spike structures 111 are arranged on each negative electrode plate 11 respectively, and similarly, each positive electrode plate 21 is correspondingly arranged. Alternatively, each first spike structure 111 is completely uniformly distributed and arranged on a negative electrode plate 11, that is, in each row, the center distance between every two adjacent first spike structures 111 is fixedly set to a first preset distance, while in each column, the center distance between every adjacent two first spike structures 111 is fixedly set to a second preset distance. Of course, those skilled in the art can understand that the first preset distance and the second preset distance may or may not be equal, and meanwhile, the specific values of the first preset distance and the second preset distance need to be matched and designed based on the actual dust removal needs, such as a waste gas treatment volume, a dust removal site, a power consumption requirement. This example is only an illustrative example, and those skilled in the art should not construe it as a limitation to this disclosure.

Further, in one example, considering the combined influence of the ambient temperature and humidity and the composition of the waste gas during the electrostatic dust removal process, it is highly possible to generate water vapor in the waste gas, which poses a serious safety risk for the electrostatic dust removal device. Alternatively, as shown in FIGS. 3 and 4, at least one liquid flow guidance channel is individually provided on the plate surfaces of each negative electrode plate 11 and each positive electrode plate 21. Specifically, for example, three sets of first liquid flow guidance channels 112 are provided on the plate surface of the negative electrode plate 11, and three sets of second liquid flow guidance channels 212 are provided on the plate surface of the positive electrode plate 21. With such an arrangement, the water vapor in the waste gas can be collected in the interiors of the first liquid flow guidance channels 112 and the second liquid flow guidance channels 212, and flow downward in the interiors thereof and converge at the bottom for collection or treatment. This prevents the water vapor from staying on the negative electrode plate 11 or the positive electrode plate 21 which causes electric sparking, and avoids safety issues such as short circuits and fires during the operation of the electrostatic field dust removal device 100. For the design of the flow guidance channel in the position, number, specific structural shape, etc., this example only provides an illustrative example, and those skilled in the art in the field can make adaptive adjustments according to the actual dust removal scenario and the processing technology, and this example should not be construed as a limitation on this disclosure.

Specifically, in an example, in combination with FIGS. 5 and 6, taking one of the negative electrode plates 11 as an example, when the electrostatic field dust removal device 100 is activated, within its electrostatic field discharge range, two functional regions can be formed at the same time, with one functional region is the electrostatic dust removal region, and the other functional region is the glow plasma region, i.e., the region A shown in FIG. 5 is the electrostatic dust removal region, and the region B is the glow plasma region. This requires that the two discharge paths are correspondingly arranged on the same negative electrode plate 11. Therefore, alternatively, at first, the negative electrode plate 11 is configured as a structure with two layers of plate surfaces, and then several first spike structures 111 in the same row or column are alternately arranged on the two layers of plate surfaces of the negative electrode plate 11, and the tips of the first spike structures 111 point outwardly from the plate surfaces on which they are located. Similarly, the corresponding arrangement is applied to the positive electrode plate 21 and the second spike structure 211 thereon. Then, after the above-described arrangement, as shown in FIGS. 5 and 6, one of the first spike structures 111 on an upper layer plate surface 11a of the negative electrode plate 11 is discharged upward to the lower layer plate surface 21b of the adjacent positive electrode plate 21, in order to form a region A for ionizing the waste gas and adsorbing the impurities or oil smoke particles to be purified. Meanwhile, a first spike structure 111 adjacent thereto is provided on the lower layer plate surface 11b of the negative electrode plate 11, and the upper layer plate surface 11a corresponding to the lower layer plate surface 11b remains a planar surface. And the planar surface discharges upward to the same positive electrode plate 21, in which a second spike structure 211 is provided on the lower layer plate surface 21b of the positive electrode plate 21 to receive the negative charges from the negative electrode plate 11, in order to form the region B. The region B is used for ionization and purification, while a glow plasma region is also formed, generating a large amount of plasma to form a plasma barrier, to physically bombard particulates to be purified, change their morphology, and increase the function of sterilizing and deodorizing.

The region A and the region B are alternately performed purifying, to improve the waste gas purification efficiency and optimize the purification effect. Those skilled in the art can understand that for the set specific location of the first spike structure 111, this example is only an illustrative one. For example, the two adjacent first spike structures 111 illustrated in FIGS. 5 and 6 are provided, one on the upper layer plate surface 11a and the other on the lower layer plate surface 11b, and so on. Of course, it is also possible to arrange every two first spike structures 11 on the upper layer plate surface 11a, and the following two first spike structures 11 on the on the lower layer plate surface 11b, and so on. And thus this example should not be understood as a limitation on this disclosure.

Specifically, in one example, as shown in FIG. 5, in order to ensure that the waste gas can sufficiently reside after entering the electrostatic field dust removal device 100 so that the impurities, powder dust, oil smoke particles, etc. therein can be sufficiently ionized and purified, the plate surfaces of the negative electrode plate 11 and the positive electrode plate 21 are arranged as wavelike plate surfaces. The arrangement of the wavelike plate surfaces makes the electrostatic field space channels also present wavelike bending channels, and the waste gas can be sufficiently ionized and purified through the bending channels, further improving the electrostatic field purification efficiency.

Further, in one example, corresponding to the example in which the first spike structure 111 and the second spike structure 211 are completely uniformly distributed on the negative electrode plate 11 and the positive electrode plate 21, alternatively, each first spike structure 111 and each second spike structure 211 are arranged at a center of a convex position or a center of a concave position of the wavelike plate surface. Specifically, as shown in FIGS. 5 and 6, alternatively, the first spike structure 111 or the second spike structure 211 on the upper layer plate surface is arranged at the center of the convex position of the wavelike plate surface of the negative electrode plate 11 or the positive electrode plate 21. Correspondingly, the first spike structure 111 or the second spike structure 211 on the lower layer plate surface is arranged at the center of the concave position of the wavelike plate surface of the negative electrode plate 11 or the positive electrode plate 21.

In the above example, the design of the wavelike plate surface is only an exemplary illustration, and those skilled in the art can make an appropriate design according to the actual dust removal requirements and the site situations, in order to construct a suitable bending channel for the flow of waste gas, and this example shall not be a limitation on this disclosure.

In one example, referring to FIG. 7, a top view of the first spike structure 111 is shown, and for each first spike structure 111 on the negative electrode plate 11, at least two discharge tips are included. As shown in FIG. 7, in this example, a total of four discharge tips 111a, 111b, 111c, and 111d which are arranged centrally symmetrically are provided. That is to say, although each first spike structure 111 is configured for a single-point discharge, it also has the single-point of four spikes as discharge tips. By doing so, the service life of the discharge tips can be extended. If there were only a unique spike, then the spike would be easily passivated during frequent use, and the passivated spike would lose its discharge function, and there would be a localized discharge failure on the same negative electrode plate 11, which affects the stability and uniformity of the electrostatic field on the negative electrode plate 11, and further influences the overall purification efficiency of the electrostatic field dust removal device 100. The positive electrode plate 21 can be disposed corresponding to the arrangement of the negative electrode plate 11, which will not be repeated herein.

Further, in an example, the number of discharge tips arranged on the first spike structure 111 or the second spike structure 211 can be adjusted according to the actual situation, such as four in the above example, or two, six, which can be arranged uniformly in pairs, or in another example, three (odd) discharge tips are arranged in a triangle, mainly for ensuring that the discharging is stable and uniform.

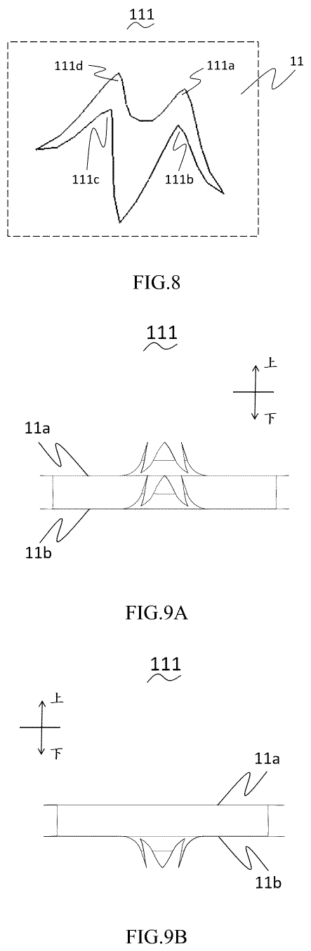

Further, referring to FIG. 8, an example of the discharge tip is shown, i.e., each discharge tip presents a triangular structure with one of the tips of the triangular structure pointing outward of the plate surface on which it is located. Of course, those skilled in the art can adjust the structure of the discharge tip by adjusting the manufacturing process, for example, by providing an opening at the tip pointing outward, or by providing multiple tips with different heights of divergence, and the like. This example is only an illustrative example, and those skilled in the art should not construe it as a limitation on this disclosure.

In one example, each first spike structure 111 can be formed through the following ways: by stamping each negative electrode plate 11, or by individually processing each first spike structure 111 and then welding it to the corresponding position on the respective plate surface of each negative electrode plate 11. Similarly to the formation of the first spike structure 111, the second spike structure 211 can also be fabricated in the above-described various ways, which will not be repeated herein. Alternatively, in this example, the plate surfaces of the negative electrode plate 11 and the positive electrode plate 21 are first fabricated by an integral stretch molding process, and then the first spike structure 111 and the second spike structure 211 are formed in such a way that the corresponding discharge tips wherein each discharge point is arranged with four spikes are made by stamping according to a pre-planned and designed layouts of the first spike structure 111 and the second spike structure 211.

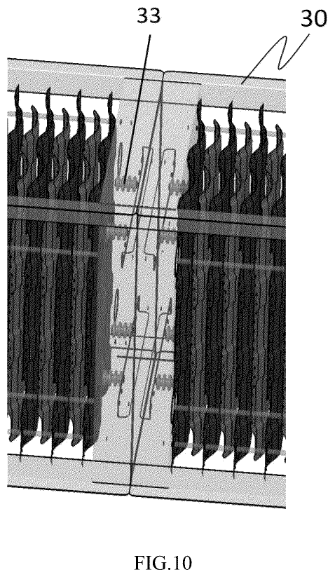

In one example, referring to FIGS. 9A and 9B, and taking the negative electrode plate surface 11 as an example, two layout ways of the first spike structure 111 on the negative electrode plate surface 11 are shown. In particular, when each first spike structure 111 on each negative electrode plate 11 is stamped, as shown in FIG. 9A, two first spike structures 111 stacked together can be formed by stamping simultaneously in the same direction on both side plate surfaces, for example, as shown in conjunction with FIGS. 5 and 6, that is, one first spike structure 111 is stamped at the same position of the upper layer plate surface 11a and the lower layer plate surface 11b, respectively, and the centers of the two first spike structures 111 are coaxial and their spikes are oriented in the same direction. As shown in FIG. 9B, a first spike structure 111 can also be formed by stamping on one side plate surface, e.g., the lower layer plate surface 11b as shown in FIGS. 5 and 6, in other words, if a first spike structure 111 is stamped on the lower layer plate surface 11b, then, correspondingly, the upper layer plate surface 11a thereof is here a flat surface. Similarly, the same layout design described above can be selected for the positive electrode plate 21, which is not repeated herein.

In one example, referring to FIG. 10, the specific location of the insulator 33 arranged on the electrostatic field dust removal device 100 is shown. As can be seen, the insulator 33 can be actually hidden within a relatively closed space through the housing 30, and isolated from the negative electrode plate 11 and the positive electrode plate 21, and meanwhile also effected isolation from the waste gas. Thus, the insulator 33 can be cleaned centrally by adding a spraying device. Alternatively, at the locations the housing 30 close to the insulator 33, for example, on the inner wall of the top of the housing 30 close to the insulator 33 above, at least one set of spray nozzles (not shown) is arranged for spraying and cleaning of the insulator 33. Alternatively, the number of spray nozzles can also be increased at suitable locations such as the middle, bottom of the housing. This example is only an illustrative example, and those skilled in the art should not construe it as a limitation on this disclosure.

In one example, referring to Tables 1 and 2, taking an electrostatic precipitation device of the 40,000 air volume class as an example, the electrostatic field dust removal device 100 of this disclosure is compared with an existing annular electrostatic field device in parameters such as volume, power, adsorption area. Compared to the existing annular electrostatic field design, the electrostatic field dust removal device 100 can be reduced in volume by about ¼ on the basis of realizing the same amount of waste gas dedusting, and the power consumption can be reduced by about ⅓. And while the purification efficiency is improved, the operating current is substantially reduced, thereby lowering the energy consumption.

TABLE 1
Comparison of performance parameters between the
electrostatic field dust removal device and the
annular electrostatic field at 40,000 air volume

| | | | | | | Number |
|---|---|---|---|---|---|---|
| | | | | Discharge | Power | of power |
| | Length | Width | Height | distance | supply | supply |
| Electro- | 1070 m | 3000 m | 2500 m | 16 m | 1500 W | 6 |
| static | | | | | | |
| field dust | | | | | | |
| removal | | | | | | |
| device | | | | | | |
| Annular | 800 m | 3000 m | 2500 m | 25 m | 800 W | 3 |
| electro- | | | | | | |
| static | | | | | | |
| field | | | | | | |

TABLE 2
Comparison of purification efficiency between the electrostatic
field dust removal device and the annular electrostatic field

| | Designed | | | Effective | | Total | | | |
|---|---|---|---|---|---|---|---|---|---|
| | absorption | | Absorption | absorption | | absorption | | | |
| | area | | ratio | area | | area | | Power | |
| Electrostatic field dust removal device | 5.33 | m² | 75% | 4 | m² | 108 | m² | 36 | kW |
| Annular electrostatic field | 8.32 | m² | 100% | 8.32 | m² | 225 | m² | ≤25 | kW |

This disclosure further provides multiple embodiments according to the following aspects, and the contents are as follows specifically:

Aspect 1: A manufacturing method for an electrostatic field dust removal device, the manufacturing method including:
manufacturing at least one negative electrode plate for releasing negative charges; and
manufacturing at least one positive electrode plate, which is alternately arranged in parallel with the at least one negative electrode plate, for receiving the negative charges released by the at least one negative electrode plate;
wherein an electrostatic dust removal region and a glow plasma region are formed between each negative electrode plate of the at least one negative electrode plate and each positive electrode plate of the at least one positive electrode plate, and waste gas flows between each negative electrode plate and each positive electrode plate and is alternately purified, wherein it is purified by corona in the electrostatic dust removal region and ionized in the glow plasma region.

Aspect 2: The manufacturing method according to aspect 1, wherein at least two first spike structures are mounted on each negative electrode plate, and each negative electrode plate releases negative charges through tips of the at least two first spike structures; and the at least two first spike structures are alternatively mounted on plate surfaces on both sides of each negative electrode plate, respectively.

Aspect 3: The manufacturing method according to aspect 2, wherein each positive electrode plate is correspondingly mounted with at least two second spike structures according to an arrangement of the at least two first spike structures on each negative electrode plate.

Aspect 4: The manufacturing method according to aspect 3, wherein both each first spike structure of the at least two first spike structures and each second spike structure of the at least two second spike structures include at least two discharge tips, wherein the at least two discharge tips include four discharge tips which are centrally symmetrically arranged, or three discharge tips which are arranged in a triangular shape.

Aspect 5: The manufacturing method according to aspect 4, wherein each first spike structure is formed through following ways: by stamping each negative electrode plate, or by individually processing each first spike structure and then welding each first spike structure on each negative electrode plate; and each second spike structure is formed through following ways: by stamping each positive electrode plate, or by individually processing each second spike structure and then welding each second spike structure on each positive electrode plate.

Aspect 6: The manufacturing method according to aspect 5, wherein when each first spike structure on each negative electrode plate and each second spike structure on each positive electrode plate are stamped, one first spike structure and one second spike structure are formed by stamping on either of the plate surfaces, or two first spike structures and two second spike structures stacked together are formed by stamping simultaneously in the same direction on both of the plate surfaces.

Aspect 7: The manufacturing method according to any one of aspects 1-6, wherein the plate surfaces of each negative electrode plate and each positive electrode plate are arranged as wavelike plate surfaces; and each first spike structure and each second spike structure are arranged at a center of a convex position or at a center of a concave position of the wavelike plate surfaces.

Aspect 8: The manufacturing method according to aspect 7, wherein at least one liquid flow guidance channel is individually provided on the plate surfaces of each negative electrode plate and each positive electrode plate.

Aspect 9: The manufacturing method according to aspect 8, wherein the electrostatic dust removal device further includes at least one set of spray nozzles for cleaning insulators, which are arranged on a wall of a housing close to the insulators of the electrostatic dust removal device.

Aspect 10: The manufacturing method according to aspect 9, wherein the electrostatic field dust removal device further includes at least one housing, wherein a set of negative electrode plates and positive electrode plates are integrally installed in each housing of the at least one housing, in order to form an electrostatic field dust removal unit; and the electrostatic field dust removal unit is integrated by connecting and fixing each housing adjacent to each other.

Aspect 11: A purification method of using an electrostatic field dust removal device manufactured by the manufacturing method according to any one of aspects 1-10, the purification method including:
directing the waste gas to be purified to pass through the electrostatic dust removal region, and to be purified by corona in the electrostatic dust removal region, wherein the electrostatic dust removal region is formed in such a way that the tips of at least two first spike structures on each negative electrode plate release negative charges towards the plate surface of the positive electrode plate directly opposite thereto;
introducing the waste gas to be purified to the glow plasma region after passing through the electrostatic dust removal region, wherein the glow plasma region is formed in such a way that a flat surface of the opposite side plate surface of the plate surface where the at least two first spike structures on each negative electrode plate are located releases negative charges towards the tips of the at least two second spike structures on the positive electrode plate directly opposite thereto, and the waste gas is ionized in the glow plasma region to achieve odor removal and sterilization; and
directing the waste gas to be purified to alternately pass through the electrostatic dust removal region and the glow plasma region arranged in sequence.

In some embodiments, at least two first spike structures are arranged on each negative electrode plate, and each negative electrode plate releases negative charges through tips of the at least two first spike structures; and the at least two first spike structures are alternatively arranged on plate surfaces on both sides of each negative electrode plate, respectively.

Further, each positive electrode plate is correspondingly arranged with at least two second spike structures according to an arrangement of the at least two first spike structures on each negative electrode plate.

In some embodiments, the electrostatic dust removal region is formed in such a way that the tips of at least two first spike structures on each negative electrode plate release the negative charges towards the plate surface of the positive electrode plate directly opposite thereto.

Further, the glow plasma region is formed in such a way that a flat surface of the opposite side plate surface of the plate surface where the at least two first spike structures on each negative electrode plate are located releases the negative charges towards the tips of the at least two second spike structures on the positive electrode plate directly opposite thereto.

In some embodiments, both each first spike structure of the at least two first spike structures and each second spike structure of the at least two second spike structures include at least two discharge tips, wherein the at least two discharge tips include four discharge tips which are centrally symmetrically arranged, or three discharge tips which are arranged in a triangular shape.

In some embodiments, each first spike structure is formed through following ways: by stamping each negative electrode plate, or by processing individually each first spike structure and then welding each first spike structure on each negative electrode plate; and each second spike structure is formed through following ways: by stamping each positive electrode plate, or by processing individually each second spike structure and then welding each second spike structure on each positive electrode plate.

In some embodiments, when each first spike structure on each negative electrode plate and each second spike structure on each positive electrode plate are stamped, one first spike structure and one second spike structure are formed by stamping on either of the plate surfaces, or two first spike structures and two second spike structures stacked together are formed by stamping simultaneously in the same direction on both of the plate surfaces.

In some embodiments, the plate surfaces of each negative electrode plate and each positive electrode plate are arranged as wavelike plate surfaces; and each first spike structure and each second spike structure are arranged at a center of a convex position or at a center of a concave position of the wavelike plate surfaces.

In some embodiments, at least one liquid flow guidance channel is individually provided on the plate surfaces of each negative electrode plate and each positive electrode plate.

In some embodiments, the electrostatic dust removal device further includes at least one set of spray nozzles for cleaning insulators, which are arranged on a wall of a housing close to the insulators of the electrostatic dust removal device.

In some embodiments, the electrostatic field dust removal device further includes at least one housing, wherein a set of negative electrode plates and positive electrode plates are integrally installed in each housing of the at least one housing, in order to form an electrostatic field dust removal unit; and the electrostatic field dust removal unit is integrated by connecting and fixing each housing adjacent to each other.

The electrostatic field dust removal device, as well as the manufacturing method thereof and the purification method thereof provided according to the embodiments of this disclosure have at least one or a part of at least one of the advantages as follows:
(1) by arranging correspondingly a spike structure at different positions on the positive and negative electrode plates, the electrostatic dust removal device provided by the embodiment of this disclosure realizes two negative charge release ways, forming an electrostatic dust removal region and a glow plasma region, and meanwhile purifying and ionizing the waste gas, so as to enhance the effect of the dust removal, as well as achieve odor removal and sterilization;
(2) the electrostatic dust removal device provided by the embodiment of this disclosure can substantially reduce the working current and lower the consumption of electric energy by means of the staggered arrangement of the positive and negative electrode plates and the tip discharge of the spike structure;
(3) by arranging multiple discharge tips on the spike structure, the electrostatic dust removal device provided by the embodiment of this disclosure effectively prevents the discharge tip from being passivated during repeated use, and extends the service life of the spike structure;
(4) by stamping on the positive and negative electrode plates to form the spike structure, the electrostatic dust removal device provided by the embodiment of this disclosure is simple to process, reduces the manufacturing cost, and also ensures that the structural stress is uniform;
(5) by arranging the positive and negative electrode plates as wavelike plates, the electrostatic dust removal device provided by the embodiment of this disclosure bends the waste gas flow channel appropriately, and guides the waste gas flow, in order to improve the efficiency of dust removal and purification of the waste gas;
(6) by arranging liquid flow guidance channels in the positive and negative electrode plates, the electrostatic dust removal device provided by the embodiment of this disclosure helps the water vapor in the dust removal process to avoid the discharge tip, and avoids the accumulation of water vapor from causing a discharge sparking that can result in a short circuit of the device, ensuring safe operation;
(7) the electrostatic dust removal device provided by the embodiment of this disclosure realizes cleaning and maintenance of the positive and negative electrode plates by arranging a spraying structure in the liquid flow guidance channel.

Although some embodiments based on the present overall inventive conception have been shown and illustrated, those skilled in the art would understand that changes can be made to these embodiments without departing from the principles and spirit of the present overall inventive conception, and the scope of this disclosure is limited only by the claims and their equivalents.

What is claimed is:

1. An electrostatic field dust removal device, wherein the electrostatic field dust removal device comprises:
at least one negative electrode plate for releasing negative charges, wherein at least two first spike structures are arranged on each negative electrode plate of the at least one negative electrode plate, the at least two first spike structures are alternatively arranged on plate surfaces on both sides of said each negative electrode plate, respectively, and said each negative electrode plate releases the negative charges through tips of the at least two first spike structures; and
at least one positive electrode plate, which is alternately arranged in parallel with the at least one negative electrode plate, for receiving the negative charges released by the at least one negative electrode plate, each positive electrode plate of the at least one positive electrode plate is correspondingly arranged with at least two second spike structures according to an arrangement of the at least two first spike structures on said each negative electrode plate;
the plate surfaces of the each negative electrode plate and the each positive electrode plate are arranged as wavelike plate surfaces; and
the each first spike structure and the each second spike structure are arranged at a center of a convex position or at a center of a concave position of the wavelike plate surfaces;
wherein an electrostatic dust removal region is formed in such a way that the tips of the at least two first spike structures on the each negative electrode plate release the negative charges towards a plate surface of the positive electrode plate directly opposite thereto, a glow plasma region is formed in such a way that a flat surface of an opposite side plate surface of the plate surface where the at least two first spike structures on said each negative electrode plate are located releases the negative charges towards the tips of the at least two second spike structures on the positive electrode plate directly opposite thereto, and
wherein waste gas flows between said each negative electrode plate and said each positive electrode plate and is alternately purified, wherein it is purified by corona in the electrostatic dust removal region and ionized in the glow plasma region.

2. The electrostatic field dust removal device according to claim 1, wherein
both each first spike structure of the at least two first spike structures and each second spike structure of the at least two second spike structures comprise at least two discharge tips,
wherein the at least two discharge tips comprise four discharge tips which are centrally symmetrically arranged, or three discharge tips which are arranged in a triangular shape.

3. The electrostatic field dust removal device according to claim 2, wherein
said each first spike structure is formed through following ways:
by stamping said each negative electrode plate, or
by processing individually said each first spike structure and then welding said each first spike structure on said each negative electrode plate; and
said each second spike structure is formed through following ways:
by stamping said each positive electrode plate, or
by processing individually said each second spike structure and then welding said each second spike structure on said each positive electrode plate.

4. The electrostatic field dust removal device according to claim 3, wherein
when said each first spike structure on said each negative electrode plate and said each second spike structure on said each positive electrode plate are stamped,
one first spike structure and one second spike structure are formed by stamping on either of the plate surfaces, or
two first spike structures and two second spike structures stacked together are formed by stamping simultaneously in the same direction on both of the plate surfaces.

5. The electrostatic field dust removal device according to claim 1, wherein
at least one liquid flow guidance channel is individually provided on the plate surfaces of said each negative electrode plate and said each positive electrode plate.

6. The electrostatic field dust removal device according to claim 5, wherein
the electrostatic field dust removal device further comprises at least one set of spray nozzles for cleaning insulators, which are arranged on a wall of a housing of the electrostatic dust removal device, and close to the insulators of the electrostatic dust removal device.

7. The electrostatic field dust removal device according to claim 6, wherein
the electrostatic field dust removal device further includes at least one housing, wherein a set of negative electrode plates and positive electrode plates are integrally installed in each housing of the at least one housing, in order to form an electrostatic field dust removal unit; and
the electrostatic field dust removal unit is integrated by connecting and fixing said each housing adjacent to each other.
